(19) United States
(12) Patent Application Publication
(10) Pub. No.: US 2023/0298610 A1
(43) Pub. Date: Sep. 21, 2023

(54) NOISE SUPPRESSION METHOD AND APPARATUS FOR QUICKLY CALCULATING SPEECH PRESENCE PROBABILITY, AND STORAGE MEDIUM AND TERMINAL

(71) Applicant: UNISOC (CHONGQING) TECHNOLOGIES CO., LTD., Chongqing (CN)

(72) Inventors: Lifang BA, Shanghai (CN); Li KANG, Shanghai (CN)

(73) Assignee: UNISOC (CHONGQING) TECHNOLOGIES CO., LTD., Chongqing (CN)

(21) Appl. No.: 18/016,058

(22) PCT Filed: Jul. 6, 2021
(86) PCT No.: PCT/CN2021/104613

§ 371 Date: Jan. 13, 2023

(30) Foreign Application Priority Data
Jul. 13, 2020 (CN) 202010670348.7

(51) Int. Cl. G10L 21/0216; G10L 25/21

(52) U.S. Cl. CPC G10L 21/0216; G10L 25/21

(57) ABSTRACT

Provided in the present disclosure are a method and an apparatus for suppressing noise by calculating a speech presence probability, a storage medium, and a terminal. The method includes: obtaining an input signal, and converting the input signal from a time-domain signal to a frequency-domain signal (S101); calculating a real-time power spectrum of the frequency-domain signal, and tracking a minimum power in the real-time power spectrum (S102); performing noise estimation based on the minimum power to obtain an estimated noise power spectrum (S103); calculating a gain coefficient based on the estimated noise power spectrum, and enhancing the frequency-domain signal based on the gain coefficient to obtain an enhanced frequency-domain signal (S104); and converting the enhanced frequency-domain signal to a time-domain signal to obtain an output signal (S105).

This application claims priority to Chinese Patent Application No. 202010670348.7, titled “NOISE SUPPRESSION METHOD AND APPARATUS FOR QUICKLY CALCULATING SPEECH PRESENCE PROBABILITY, AND STORAGE MEDIUM AND TERMINAL”, filed on Jul. 13, 2020 with the China National Intellectual Property Administration, which is incorporated herein by reference in its entirety.

### FIELD

The present disclosure relates to the technical field of speech communication, and in particular to a method and an apparatus for suppressing noise by quickly calculating a speech-presence probability, a storage medium and a terminal.

### BACKGROUND

During a real-time speech communication and transmission of speech messages based on a Voice over Internet Protocol (VOIP), ambient noise and speech interference from people nearby may be picked up by a microphone at a near end of a device. Therefore, the picked-up speech usually has a low signal-to-noise ratio (SNR). If a signal is transmitted without being processed, noise in the signal may interfere with an understanding of conversation content by a remote terminal. In addition, if the noise is not processed properly, the speech at the near end may be distorted and thereby an intelligibility of the speech is affected. For example, in the field of human-computer interaction, recognition of a controller voice by an interactive terminal is interfered due to ambient noise picked up by a microphone, which results in a reduced accuracy of speech recognition and difficulties in interactions.

Various methods for noise suppression are proposed in the conventional technology. The noise suppression is mainly aimed at suppressing a noise component in a noisy speech and obtaining a cleaner speech signal. However, the noise in the noisy speech cannot be suppressed quickly and accurately through the conventional methods.

### SUMMARY

A technical problem to be solved by the present disclosure is how to suppress noise in a noisy speech quickly and accurately.

To solve the above technical problem, a method for suppressing noise by quickly calculating a speech presence probability is provided according to an embodiment of the present disclosure. The method includes: obtaining an input signal, and converting the input signal from a time-domain signal to a frequency-domain signal; calculating a real-time power spectrum of the frequency-domain signal, and tracking a minimum power in the real-time power spectrum; performing noise estimation based on the minimum power to obtain an estimated noise power spectrum; calculating a gain coefficient based on the estimated noise power spectrum, and enhancing the frequency-domain signal based on the gain coefficient to obtain an enhanced frequency-domain signal; and converting the enhanced frequency-domain signal to a time-domain signal to obtain an output signal.

In an embodiment, the performing noise estimation based on the minimum power to obtain an estimated noise power spectrum includes: calculating a ratio of a real-time power to the minimum power in the real-time power spectrum; obtaining a threshold, and comparing the ratio with the threshold to obtain a prior probability of speech absence; calculating a posterior signal-to-noise ratio based on the real-time power spectrum, where the posterior signal-to-noise ratio is a ratio of a real-time power of a current frame to an estimated noise power of a previous frame; calculating a prior signal-to-noise ratio through a decision-directed approach; calculating a speech presence probability based on the prior signal-to-noise ratio, the posterior signal-to-noise ratio, and the prior probability of speech absence; and calculating the estimated noise power spectrum based on the speech presence probability.

In some embodiments, a calculation for the obtaining a threshold and comparing the ratio with the threshold to obtain a prior probability of speech absence is expressed by:

$$q ( m , k ) = \{ \begin{matrix}0 , & Srk \geq Δ \\ 1 , & Srk \leq alpha \times Δ \\ \frac{Δ - Srk}{Δ - alpha \times Δ} , & alpha \times Δ < Srk < Δ\end{matrix}$$

where Pₘᵢₙ(m, k) represents a minimum power of a noisy speech at a k-th frequency of an m-th frame; P(m,k) represents a smoothed real-time power at the k-th frequency of the m-th frame; Srk represents the ratio and satisfies

$$Srk = \frac{P ( m , k )}{{P}_{min} ( m , k )} ;$$

alpha represents a predetermined constant and ranges from 0 to 1; Δ represents a threshold set by frequencies based on a characteristic of noise distribution; and q(m, k) represents the prior probability of speech absence at the k-th frequency of the m-th frame.

In an embodiment, the threshold is set by frequencies based on a characteristic of noise distribution according to the following equation:

Δ=a×(tanhw₁(x−thres)+b)+c

where a, b, and c represent predetermined constants, thres represents a predetermined value based on a signal-to-noise ratio of a current frame of a speech signal, and w₁ represents a constant for restricting a mapping curvature of a curve consisting of values of Δ, where w₁ ranges from 0 to 1.

In an embodiment, the calculating a speech presence probability based on the prior signal-to-noise ratio, the posterior signal-to-noise ratio, and the prior probability of speech absence includes: calculating a likelihood ratio based on the prior signal-to-noise ratio and the posterior signal-to-noise ratio, where the likelihood ratio indicates a ratio of a probability that a received data frame conforms to a distribution of a noisy speech signal to a probability that the data frame conforms to a distribution of a noise signal; and calculating the speech presence probability based on the likelihood ratio and the prior probability of speech absence.

In an embodiment, the noisy speech signal and the noise signal each satisfies a Gaussian distribution, and the likelihood ratio is expressed as:

$$Λ ( m , k ) = \frac{exp ( σ ( m , k ) \times \frac{ρ ( m , k )}{( ρ ( m , k ) + 1 )} )}{ρ ( m , k ) + 1}$$

where Λ(m, k) represents the likelihood ratio at the k-th frequency of the m-th frame; σ(m, k) represents the posterior signal-to-noise ratio at the k-th frequency of the m-th frame; ρ(m, k) represents the prior signal-to-noise ratio at the k-th frequency of the m-th frame; and exp( ) represents an exponential function having a natural constant e as a base, and an exponent indicated in parentheses.

In an embodiment, the speech presence probability is calculated based on the likelihood ratio and the prior probability of speech absence according to the following equation:

$$phat ( m , k ) = \frac{( 1 - q ( m , k ) ) Λ ( m , k )}{q ( m , k ) + ( 1 - q ( m , k ) ) Λ ( m , k )}$$

where phat(m, k) represents the speech presence probability at the k-th frequency of the mth frame; and q(m, k) represents the prior probability of speech absence at the k-th frequency of the m-th frame.

In an embodiment, after the calculating a likelihood ratio based on the prior signal-to-noise ratio and the posterior signal-to-noise ratio, the method further includes: performing an inter-frequency smoothing on the likelihood ratio to obtain a smoothed likelihood ratio. The calculating a speech presence probability based on the likelihood ratio and the prior probability of speech absence includes: calculating the speech presence probability based on the smoothed likelihood ratio and the prior probability of speech absence.

In an embodiment, after the calculating the speech presence probability based on the likelihood ratio, the prior signal-to-noise ratio, and the prior probability of speech absence, the method further includes: obtaining a probability threshold, and determining whether to update the speech presence probability based on a relationship between a posterior probability of speech presence and the probability threshold.

In an embodiment, a smoothed value of the speech presence probability is calculated as:

phatₛₘₒₒₜₕ(m, k)=α×phatₛₘₒₒₜₕ(m−1,k)+(1−α)×phat(m,k)

where phatₛₘₒₒₜₕ(m,k) represents the smoothed value of the speech presence probability at the k-th frequency of the m-th frame; and a represents a predetermined constant and ranges from 0 to 1. The speech presence probability is updated as:

$$phat ( m , k ) = \{ \begin{matrix}{phat}_{max} , & {phat}_{smooth} \geq {phat}_{max} \\ \frac{( 1 - q ( m , k ) ) {Λ}_{smooth}}{q ( m , k ) + ( 1 - q ( m , k ) ) {Λ}_{smooth}} , & {phat}_{smooth} < {phat}_{max}\end{matrix} ,$$

where phatₘₐₓ represents the probability threshold and is a predetermined constant.

In an embodiment, in a case that the estimated noise power spectrum does not contain the estimated noise power of the previous frame, the posterior signal-to-noise ratio is calculated by using a current real-time power as the estimated noise power of the previous frame.

In an embodiment, the calculating a gain coefficient based on the estimated noise power spectrum, and enhancing the frequency-domain signal based on the gain coefficient to obtain an enhanced frequency-domain signal includes: calculating a posterior signal-to-noise ratio of the frequency-domain signal based on the estimated noise power spectrum, and updating the prior signal-to-noise ratio based on the posterior signal-to-noise ratio of the frequency-domain signal; calculating a prior probability of speech absence based on the updated prior signal-to-noise ratio; calculating an updated speech presence probability based on the posterior signal-to-noise ratio, the updated prior signal-to-noise ratio, and the prior probability of speech absence, obtaining the gain coefficient based on the updated speech presence probability; and calculating a product of the frequency-domain signal and the gain coefficient, to obtain the enhanced frequency-domain signal.

In an embodiment, the prior probability of speech absence is calculated based on the updated prior signal-to-noise ratio according to the following equation:

$$d ( m , k ) = \{ \begin{matrix}0 , & {\hat{ρ}}_{1} ( m , k ) \geq {ρ}_{max} ( m , k ) \\ 1 , & {\hat{ρ}}_{1} ( m , k ) \leq {ρ}_{min} ( m , k ) \\ \frac{{ρ}_{max} ( m , k ) - {\hat{ρ}}_{1} ( m , k )}{{ρ}_{max} ( m , k ) - {ρ}_{min} ( m , k )} , & \begin{matrix}{ρ}_{min} ( m , k ) < {\hat{ρ}}_{1} ( m , k ) < \\ {ρ}_{max} ( m , k )\end{matrix}\end{matrix} ,$$

where d(m, k) represents the prior probability of absence of speech; \hat{ρ}₁(m, k) represents the updated prior signal-to-noise ratio; ρₘₐₓ(m, k) represents a maximum value of the prior signal-to-noise ratio; pₘᵢₙ(m, k) represents a minimum value of the prior signal-to-noise ratio, where ρₘₐₓ(m, k) and ρₘᵢₙ(m, k) are predetermined.

An apparatus for suppressing noise by quickly calculating a speech presence probability is further provided according to an embodiment of the present disclosure. The apparatus includes: a time-frequency conversion module, configured to obtain an input signal, and convert the input signal from a time-domain signal to a frequency-domain signal; a minimum tracking module, configured to calculate a real-time power spectrum of the frequency-domain signal, and track a minimum power in the real-time power spectrum; a noise power spectrum calculation module, configured to perform noise estimation based on the minimum power to obtain an estimated noise power spectrum; a speech enhancement module, configured to calculate a gain coefficient based on the estimated noise power spectrum, and enhance the frequency-domain signal based on the gain coefficient to obtain an enhanced frequency-domain signal; and an output module, configured to convert the enhanced frequency-domain signal to a time-domain signal to obtain an output signal.

A storage medium storing a computer program is further provided according to an embodiment of the present disclosure. The computer program, when executed by a processor, performs the method for suppressing noise by quickly calculating a speech presence probability.

A terminal is further provided according to an embodiment of the present disclosure. The terminal includes the apparatus for suppressing noise by quickly calculating a speech presence probability. Alternatively, the terminal includes a processor and a memory storing a computer program. The processor, when executing the computer program, performs the method for suppressing noise by quickly calculating a speech presence probability.

Advantageous of the technical solutions according to the embodiments of the present disclosure, compared to the conventional technology, are described below.

In the method for suppressing noise by quickly calculating a speech presence probability according to the embodiments of the present disclosure, the minimum of the real-time power spectrum is tracked in the noise estimation stage through the continuous spectrum minimum tracking method, so that an update rate of the noise spectrum is increased. The prior probability of speech absence is calculated, so that the noise power spectrum is estimated accurately. The speech signal is enhanced, so that the noise is suppressed accurately. With the technical solutions of the present disclosure, a systematic performance of noise suppression is optimized under an acceptable algorithm complexity. In addition, the method for suppressing noise is not limited by hardware resources of a terminal. Therefore, the present disclosure has a wide range of application.

Further, the minimum in the smoothed real-time power spectrum is tracked through the continuous spectrum minimum tracking method, and the threshold is set by frequencies based on the characteristic of noise distribution, so that the prior probability of speech absence in the input signal is calculated. In addition, the speech presence probability of each data frame is calculated based on only the prior signal-to-noise ratio, the posterior signal-to-noise ratio, and the prior probability of speech absence. Therefore, computation is saved, and the speech presence probability can be estimated more accurately. In this case, the speech presence probability is a posterior probability of speech presence. The noise in the input signal is accurately estimated based on the prior probability of speech absence and the posterior probability of speech presence.

Further, the noisy speech signal and the noise signal each is expressed under a Gaussian distribution. Hence, a relationship between the likelihood ratio and the prior signal-to-noise ratio and the posterior signal-to-noise ratio is established, and a posterior coefficient of the speech presence probability in each data frame is represented with the prior signal-to-noise ratio and the posterior signal-to-noise ratio.

Further, a method for calculating a speech presence probability in a continuous spectrum and a method for noise estimation based on the speech presence probability in the continuous spectrum are provided, so that the speech presence probability in the continuous spectrum is tracked continuously and a result of the noise estimation is updated in real-time.

Further, a simplified OMLSA algorithm is applied to calculate the gain and thereby obtain an enhanced speech. The calculation of a “local” or “global” likelihood probability of speech presence in the OMLSA algorithm is replaced by calculation of the prior probability of absence of a single speech. Hence, calculation of the prior probability of speech absence is simplified without influencing a performance of noise suppression, so that the computational complexity is reduced.

With the technical solutions of the present disclosure, noise in the noisy speech can be suppressed quickly and accurately. The technical solutions according to the present disclosure have the following advantages compared to the conventional noise estimation algorithms. Compared with calculation of the prior probability of speech absence according to the MCRA2, a linear threshold is used for the ratio of the smoothed speech signal power to the minimum of the noise power spectrum in the embodiments of the present disclosure, which solves the overestimation in the MCRA2 and thus the noise power spectrum can be estimated accurately and efficiently. Compared with the IMCRA, the minimum is tracked faster and the calculation is simpler in the present disclosure. Compared with the conventional OMLSA algorithm, the calculation of the prior probability of speech absence in the present disclosure is simplified while ensuring an effect of speech enhancement, so that a complexity of the algorithm is reduced.

### BRIEF DESCRIPTION OF THE DRAWINGS

FIG. 1 illustrates a schematic flowchart of a method for suppressing noise by quickly calculating a speech presence probability according to an embodiment of the present disclosure;

FIG. 2 illustrates a schematic flowchart of step S103 in FIG. 1 according to an embodiment;

FIG. 3 illustrates a schematic flowchart of step S104 in FIG. 1 according to an embodiment;

FIG. 4 illustrates a schematic diagram of a noise suppression system in an application example of the present disclosure; and

FIG. 5 illustrates a schematic structural diagram of an apparatus for suppressing noise by quickly calculating a speech presence probability according to an embodiment of the present disclosure.

### DETAILED DESCRIPTION OF THE EMBODIMENTS

As mentioned in the background section, existence of noise in a communication interferes with speech transmission.

To solve the problem, various methods for noise suppression are adopted in conventional technologies. The noise suppression typically includes noise estimation and gain calculation. The noise estimation involves two aspects, i.e., a speed of noise tracking and an accuracy of noise estimation. The accuracy of noise estimation directly affects a final effect of the noise suppression. In a case that the noise is overestimated, weak speech may be removed when filtering out the noise, resulting in speech distortion. In a case that the noise is underestimated, much background noise may be remained after filtering out the noise. Especially in a case that the background noise is non-stationary, estimation of the noise is difficult due to a rapid change of the noise, and much noise is to be remained. Therefore, it is necessary to track the noise continuously. Some widely used methods for noise estimation include a Minima-Controlled Recursive Average (MCRA) algorithm, a modified MCRA algorithm (known as MCRA2) and an improved MCRA (IMCRA) algorithm. With the above algorithms, a noise power spectrum is updated in a pure noise segment, and the noise power spectrum remains unchanged in a speech segment. Thereby, changes of the non-stationary noise can be tracked to a certain extent. In the MCRA algorithm, the noise estimation is performed by using recursive averaging. A speech presence probability in a current frame is obtained by calculating a ratio of a current value of the power spectrum of a noisy speech to a local minimum in a certain time window and comparing the ratio with a threshold. The speech presence probability and a time smoothing factor obtained from the speech presence probability are restricted by a spectral minimum. With presence of a speech, an estimated value of noise of a previous frame is determined as an estimated value of noise of the current frame; and without the presence of the speech, a power spectrum of the current frame and a first-order recursion of the noise estimation of the previous frame are calculated and used to update a noise spectrum. In the MCRA2, a continuous spectral minimum tracking method is adopted, with which a minimum is tracked continuously without being limited by a length of a window, realizing a quick tracking of the minimum. The IMCRA is an improved algorithm based on the MCRA. In the IMCRA, smoothing is performed twice and searching for a minimum is performed twice. A first recursion is performed in order to obtain a rough determination of presence of a speech. A second recursion is performed based on the determination, so as to finally obtain a speech presence probability and a time smoothing factor, where a compensation parameter is added. Table 1 provides a comparison of advantages and disadvantages of the above three algorithms in terms of a tracking speed, a computational complexity, and the like.

TABLE 1

| Algorithms | Advantages and disadvantages |
|---|---|
| MCRA | Low tracking speed and low |
| | computational complexity |
| IMCRA | High tracking speed and high |
| | computational complexity |
| MCRA2 | High tracking speed, low computational |
| | complexity, and overestimation |

The MCRA algorithm has a large delay due to existence of a search window, but has a low computational complexity. The IMCRA is an improved algorithm based on the MCRA. According to the IMCRA, a minimum search window is divided into several sub-windows when tracking a minimum. Hence, a time delay is shortened, and noise in the speech is estimated more accurately, so that an overestimation, an underestimation and the delay are optimized. However, the IMCRA algorithm has complex computations. In the MCRA2, the continuous spectrum minimum tracking method is not limited by a length of a window, so that a quick tracking of the minimum can be realized. The MCRA2 is superior to the MCRA in terms of the accuracy of noise estimation. However, the noise power spectrum may be overestimated.

In addition, conventional methods for calculating a gain include spectral subtraction, Wiener filtering, and an optimally modified LSA estimator (OMLSA). The spectral subtraction does not use any explicit speech model. A performance of the spectral subtraction depends on tracking of the spectrum of a noisy speech. Moreover, the spectral subtraction is apt to cause musical noise. The Wiener filtering is based on a statistical model, and can effectively suppress stationary noise. However, an effect of noise suppression is reduced in a case of an expected statistical feature, such as non-stationary noise. The OMLSA is frequently used for calculating a gain. The OMLSA combines the speech presence probability and a modified logarithmic minimum mean square error (MMSE) estimator, so as to minimize a difference between an expected clean speech and an estimated clean speech. However, OMLSA has complex computations when calculating a prior probability of speech absence.

In summary, conventional methods for suppressing noise cannot suppress noise in a noisy speech quickly and accurately.

To solve the above problem, a method and an apparatus for suppressing noise by quickly calculating a speech presence probability, a storage medium, and a terminal are provided according to embodiments of the present disclosure. The method includes: obtaining an input signal, and converting the input signal from a time-domain signal to a frequency-domain signal; calculating a real-time power spectrum of the frequency-domain signal, and tracking a minimum power in the real-time power spectrum; estimating noise based on the minimum power, to obtain an estimated noise power spectrum; calculating a gain coefficient based on the estimated noise power spectrum, and enhancing the frequency-domain signal based on the gain coefficient, to obtain an enhanced frequency-domain signal; and converting the enhanced frequency-domain signal to a time-domain signal to obtain an output signal.

In order to make the above objectives, features and advantageous effects of the present disclosure more apparent and understandable, specific embodiments of the present disclosure are described in detail below in conjunction with the accompanying drawings.

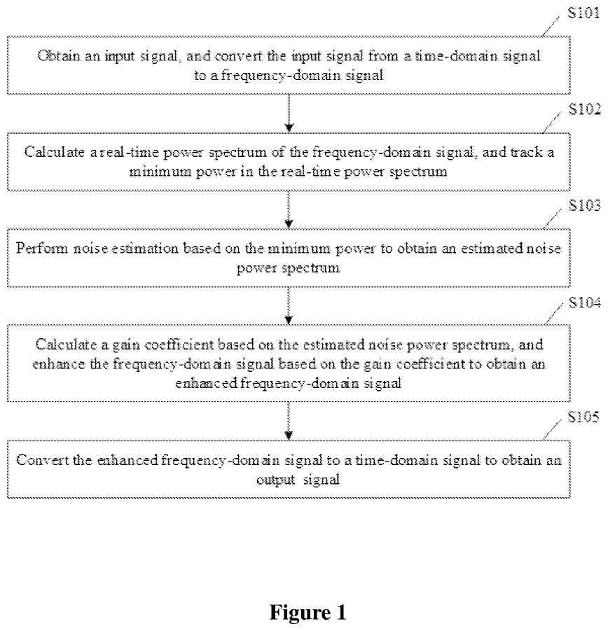

In order to solve the above technical problems, a method for suppressing noise by quickly calculating a speech presence probability is provided according to an embodiment of the present disclosure. Reference is made to FIG. 1. The method includes steps S101 to S105.

In S101, an input signal is obtained, and the input signal is converted from a time-domain signal to a frequency-domain signal.

The input signal is a speech signal to be analyzed, which may be a speech signal captured by a microphone of a speech device, such as a telephone. The input signal is a time-domain signal. A time-frequency conversion is the performed on the input signal, so as to obtain a frequency-domain signal corresponding to the input signal. Multiple pre-processes may be performed on the input signal, in order to convert the input signal to the frequency-domain signal and ensure that noise suppression is performed in a frequency domain.

Assuming that a speech signal is interfered by additive noise and that the input signal is uncorrelated with a clean speech signal, the input signal is expressed in a time domain as:

y(t)=x(t)+n(t) (1),

where y(t) represents the input signal received at a near end, x(t) represents the clean speech signal, and n(t) represents ambient noise or interference from people nearby.

In an example, the input signal is converted from a time-domain signal to a frequency-domain signal after a signal analysis stage including one or more pre-processes such as windowing, framing and Fourier transform.

In S102, a real-time power spectrum of the frequency-domain signal is calculated, and a minimum power in the real-time power spectrum is tracked.

In the frequency domain, equation (1) may be converted into the following equation (2):

Y(m, k)=X(m, k)+N(m, k) (2).

In equation (2), Y(m, k) represents a spectrum of a noisy speech, which illustrates a frequency-domain signal at a k-th frequency of an m-th frame; X(m, k) represents the spectrum of clean speech; and N(m, k) represents a spectrum of noise, where k represents a frequency, and m represents a frame index.

The real-time power spectrum obtained after calculated may be expressed as |Y(m, k)|², representing a real-time power at the k-th frequency of the m-th frame.

In an embodiment, after calculating the real-time power spectrum at a frequency of a signal frame in the frequency-domain signal and before tracking the minimum power in the power spectrum, step S102 may further include: smoothing the real-time power spectrum to obtain a smoothed real-time power spectrum. The tracking the minimum power in the real-time power spectrum may include: tracking a minimum power in the smoothed real-time power spectrum.

In an embodiment, the smoothing the real-time power spectrum to obtain a smoothed real-time power spectrum includes: performing inter-frequency smoothing on the real-time power spectrum; and performing inter-frame smoothing on the real-time power spectrum obtained after the inter-frequency smoothing, to obtain the smoothed real-time power spectrum.

Smoothing on the real-time power spectrum may be performed twice. A first smoothing is the inter-frequency smoothing, that is, the smoothing is performed on frequencies in the real-time power spectrum, to avoid a truncation effect or a windowing effect, and reduce spectrum leakage. A second smoothing is the inter-frame smoothing, that is, the smoothing is performed on frames in the real-time power spectrum, to reduce peak phenomenon at an isolated frequency. Without the inter-frame smoothing, the minimum of the real-time power spectrum has a singular value, and the singular value is small. During the smoothing, a smoothing factor may be set based on industry experience. With a greater smoothing factor, a greater value of the minimum of the power spectrum is obtained during the tracking of the minimum.

After the inter-frame smoothing, the minimum of the real-time power spectrum is tracked. The continuous spectrum minimum tracking algorithm used in the present disclosure realizes a fast tracking of the noise signal, and has less computation compared to a minimum statistical algorithm.

In an embodiment, calculation of the inter-frame smoothing may be performed with the following equation:

P′(m,k)=αP(m−1,k)+(1−α)|Y(m,k)|²

where P′(m, k) represents a real-time power at the k-th frequency of the m-th frame after the smoothing, or may represent the smoothed real-time power spectrum; P(m−1, k) represents a real-time power at the k-th frequency of a previous frame (i.e., the (m-−1)-th frame), and α represents a predetermined smoothing factor, where 0≤α≤1.

In the above embodiment, the smoothed real-time power P′(m, k) is calculated as described above, and then Step S102 is performed with the real-time power P(m, k) being replaced by the smoothed real-time power P′(m, k).

After the input signal is converted to the frequency-domain signal and the real-time power spectrum of the frequency-domain signal is calculated, the smoothing is firstly 25 performed on the real-time power spectrum. The smoothing may include the inter-frequency smoothing and the inter-frame smoothing. In this way, the spectral leakage is reduced and jump of characteristics of the noise spectrum is avoided (so as to enable basic filtering and noise reduction on the real-time power spectrum). Thereby, the accuracy of noise suppression of the input signal is improved.

In S103, noise estimation is performed based on the minimum power to obtain an estimated noise power spectrum.

The minimum of the power spectrum of the noisy speech is tracked by using a continuous spectrum minimum tracking algorithm. Noise at the tracked frequency is then analyzed to obtain the estimated noise power spectrum.

In S104, a gain coefficient is calculated based on the estimated noise power spectrum, and the frequency-domain signal is enhanced based on the gain coefficient to obtain an enhanced frequency-domain signal.

The gain coefficient is used to enhance the frequency-domain signal. The gain coefficient may be calculated based on the estimated noise power spectrum.

In S105, the enhanced frequency-domain signal is converted to a time-domain signal to obtain an output signal.

An inverse Fourier transform, window synthesis, and other processes are performed on a spectrum of the enhanced frequency-domain speech signal, so as to converted to the time-domain. Thereby, the output signal is obtained.

According to the technical solution of the present disclosure, the minimum of the real-time power spectrum is tracked in the noise estimation stage through the continuous spectrum minimum tracking method, so that an update rate of the noise spectrum is increased. The prior probability of speech absence is calculated, so that the noise power spectrum is estimated accurately. The speech signal is enhanced, so that the noise is suppressed accurately. With the technical solutions of the present disclosure, a systematic performance of noise suppression is optimized under an acceptable algorithm complexity. In addition, the method for suppressing noise is not limited by hardware resources of a terminal. Therefore, the present disclosure has a wide range of application.

In an embodiment, the tracking the minimum power in the real-time power spectrum in step S102 may be performed by using the following equation (3):

$${P}_{min} ( m , k ) = \qquad \text{(3)}$$

$$\{ \begin{matrix}\begin{matrix}γ {P}_{min} ( m - 1 , k ) + \\ \frac{1 - γ}{1 - β} ( P ( m , k ) - β P ( m - 1 , k ) )\end{matrix} , & {P}_{min} ( m - 1 , k ) < P ( m , k ) \\ P ( m , k ) , & otherwise\end{matrix} .$$

In equation (3), Pₘᵢₙ(m, k) represents a minimum power of a noisy speech at the k-th frequency of the m-th frame; Pₘᵢₙ(m−1, k) represents a minimum power of the noisy speech of the (m−1)-th frame; β and γ each represents a predetermined empirical coefficient; and P(m, k) represents a real-time power spectrum at the k-th frequency of the m-th frame.

In an embodiment, adjustment to β may change an adaptation time of the algorithm. In an example, increase of β results in decrease of time for tracking.

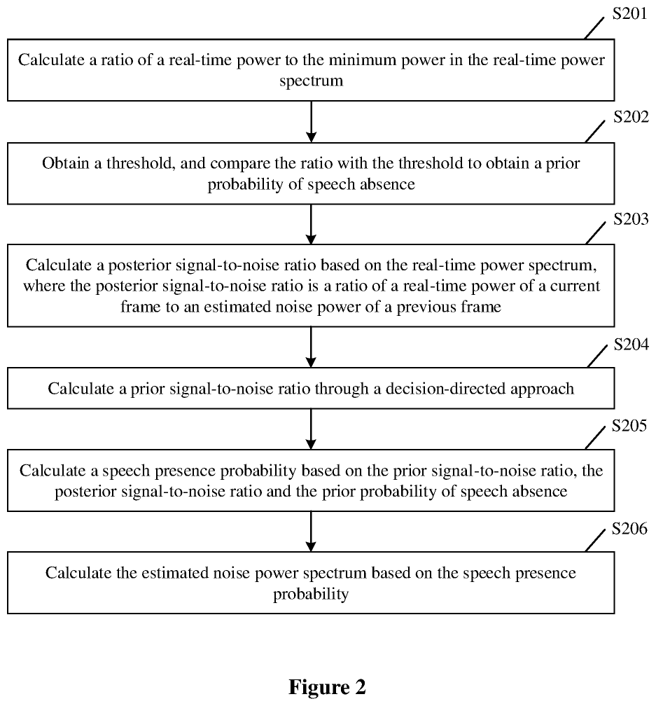

Reference is made to FIG. 1 and FIG. 2. In an embodiment, step S103 of performing noise estimation based on the minimum power to obtain an estimated noise power spectrum, as shown in FIG. 1, may include steps S201 to S206 as in FIG. 2.

In step S201, a ratio of a real-time power to the minimum power in the real-time power spectrum is calculated.

The real-time power is a power corresponding to the real-time power spectrum at the k-th frequency of the m-th frame, and is represented as P(m, k). The minimum power in the real-time power spectrum is represented as Pₘᵢₙ(m, k), i.e., the minimum power of the noisy speech at the k-th frequency of the m-th frame. The ratio Srk of the real-time power to the minimum power in the real-time power spectrum may be expressed as the following equation (4)

$$Srk = \frac{P ( m , k )}{{P}_{min} ( m , k )} \qquad ( 4 )$$

In step S202, a threshold is obtained, and the ratio is compared with the threshold to obtain a prior probability of speech absence.

The prior probability of speech absence indicates a probability that there is no speech signal at the k-th frequency of the m-th frame in the real-time power spectrum obtained by analyzing based on the ratio Srk obtained through equation (4).

The threshold is used to determine the prior probability of speech absence at a frequency in the power spectrum corresponding to the ratio Srk. The threshold may be set by frequencies based on a characteristic of noise distribution. The threshold may be set optimally based on experiments or experience. The threshold is used to determine the prior probability of speech absence at a frequency in a frame of the real-time power spectrum, based on which a region of the real-time power spectrum where a speech exists is determined.

In an embodiment, the prior probability of speech absence at a frequency in the power spectrum corresponding to the ratio Srk may be determined based on the following equation (5):

$$q ( m , k ) = \{ \begin{matrix}0 , & Srk \geq Δ \\ 1 , & Srk \leq alpha \times Δ \\ \frac{Δ - Srk}{Δ - alpha \times Δ} , & alpha \times Δ < Srk < Δ\end{matrix} . \qquad ( 5 )$$

In equation (5), Srk represents the ratio, alpha represents a predetermined constant ranging from 0 to 1, Δ represents the threshold set by frequencies based on a characteristic of noise distribution, and q(m, k) represents the prior probability of speech absence at the k-th frequency of the m-th frame.

In a case that q(m, k)=0, it may be determined that the frequency band is a pure speech signal, i.e., a pure speech segment. In a case that q(m, k)=1, it may be determined that there is no speech signal in the frequency band, that is, the frequency band is a pure noise segment. For the pure noise segment, most of values of the ratio Srk are distributed between 1 and 2, counting for about 50%. In other cases, the speech signal may or may not exist. An estimator provides a gentle transition between presence and absence of the speech, and such frequency band may be referred to as a noisy speech segment. In this case, the ratio Srk is distributed evenly. A change of amplitude of the noisy speech segment becomes great as the ratio Srk increases.

Further, the threshold in equation (5) may be set by frequencies based on a characteristic of noise distribution according to the following equation (6):

Δ=a×(tanh w₁(x−thres)+b)+c (6).

In equation (6), a, b, and c represent predetermined constants; thres represents a predetermined value based on a signal-to-noise ratio of a speech signal of the current frame; and W₁ represents a constant for restricting a mapping curvature of a curve consisting of values of Δ, where W₁ ranges from 0 to 1.

In an embodiment, thres varies with the signal-to-noise ratio of the speech signal of the current frame. In a case that the signal-to-noise ratio is low, thres decreases and Δ increases. In a case that the signal-to-noise ratio is high, thres increases and the Δ decreases.

When calculating the prior probability of speech absence, thresholds Δ are set independently for frequencies according to distribution of a current speech signal. The thresholds for frequencies may be adaptively adjusted based on the signal-to-noise ratio of the speech signal of the current frame. A mapping function for updating the thresholds Δ may be “s”-shaped. In a case that the signal-to-noise ratio is high, the Δ is reduced so as to retain more speech components. In a case that the signal-to-noise ratio is low, the Δ is increased so as to enhance noise suppression.

In step S203, a posterior signal-to-noise ratio is calculated based on the real-time power spectrum, where the posterior signal-to-noise ratio is a ratio of a real-time power of the current frame to an estimated noise power of a previous frame.

The posterior signal-to-noise ratio is a transient signal-to-noise ratio based on an observed real-time power spectrum of the input signal associated with the estimated noise power spectrum. The posterior signal-to-noise ratio is calculated by using the following equation (7):

$$σ ( m , k ) = \frac{{\vert Y ( m , k ) \vert}^{2}}{{\vert \hat{N} ( m - 1 , k ) \vert}^{2}} . \qquad ( 7 )$$

In equation (7), σ(m, k) represents the posterior signal-to-noise at the k-th frequency of the m-th frame; |Y(m,k)|² represents the real-time power spectrum; and |\hat{N}(m−1,k)|² represents the noise power spectrum at the k-th frequency of a previous frame (i.e., the (m−1)-th frame).

In step S204, a prior signal-to-noise is calculated through a decision-directed approach.

The prior signal-to-noise may be calculated by using the following equation (8):

ρ(m,k)=max(γ_{d}ρ(m−1,k)+(1−γ_{d})max(σ(m,k)−1,0),ρₘᵢₙ) (8).

In equation (8), ρ(m, k) represents the prior signal-to-noise ratio at the k-th frequency of the m-th frame; γ_{d} represents a predetermined smoothing factor, where γ_{d} ranges from 0 to 1; ρ(m−1,k) represents the prior signal-to-noise ratio at the k-th frequency of a previous frame (i.e., the (m−1)-th frame); ρₘᵢₙ represents a minimum available for ρ(m, k), and may be a constant set empirically in order to control a degree of noise reduction, where a smaller ρₘᵢₙ results in a higher degree of noise reduction and a higher distortion of the speech signal; and max( ) represents an operation of taking a maximum value.

In step S205, a speech presence probability is calculated based on the prior signal-to-noise ratio, the posterior signal-to-noise ratio, and the prior probability of speech absence.

In step S206, the estimated noise power spectrum is calculated based on the speech presence probability.

In the embodiment, the minimum in the smoothed real-time power spectrum is tracked through the continuous spectrum minimum tracking method, and the threshold is set by frequencies based on the characteristic of noise distribution, so that the prior probability of speech absence in the input signal is calculated. In addition, the speech presence probability of each data frame is calculated based on only the prior signal-to-noise ratio, the posterior signal-to-noise ratio, and the prior probability of speech absence. Therefore, computation is saved, and the speech presence probability can be estimated more accurately. In this case, the speech presence probability is a posterior probability of speech presence. The noise in the input signal is accurately estimated based on the prior probability of speech absence and the posterior probability of speech presence.

In an embodiment, the calculating speech presence probability based on the prior signal-to-noise ratio, the posterior signal-to-noise ratio, and the prior probability of speech absence in step S205 may include: calculating a likelihood ratio based on the prior signal-to-noise ratio and the posterior signal-to-noise ratio, where the likelihood ratio represents a ratio of a probability that a received data frame conforms to distribution of a noisy speech signal to a probability that a data frame conforms to distribution of a noise signal; and calculating the speech presence probability based on the likelihood ratio and the prior probability of speech absence.

The probability that a data frame conforms to distribution of a noisy speech signal is represented by P(Y(m, k)|H₁), and the probability that a data frame conforms to distribution of a noise signal is represented by P(Y(m, k)|H₀), where H₁ represents a noisy speech state and H₀ represents a pure noise state. Hence, the likelihood ratio may be expressed by the following equation (9).

$$Λ ( m , k ) = \frac{P ( Y ( m , k ) \vert {H}_{1} )}{P ( Y ( m , k ) \vert {H}_{0} )} \qquad ( 9 )$$

That is, in a process of calculating the speech presence probability for each data frame, the data is matched to the distribution of the noisy speech signal and the distribution of the pure noise signal, respectively, so as to calculate a corresponding likelihood ratio.

In an embodiment, the pure noise signal (i.e., N(m, k) in equation (2)) may be considered satisfying a Gaussian distribution. Hence, the probability P(Y(m,k)|H₀) that a data frame conforms to distribution of a noise signal may be further expressed by the following equation (10):

$$P ( Y ( m , k ) \vert {H}_{0} ) = \frac{1}{{\vert N ( m , k ) \vert}^{2}} \times exp ( - \frac{{\vert Y ( m , k ) \vert}^{2}}{{\vert N ( m , k ) \vert}^{2}} ) . \qquad ( 10 )$$

The noisy speech signal (that is, Y(m,k) in equation (2)) may be considered as a speech signal having additive noise, and also satisfies the Gaussian distribution. Hence, the probability P(Y(m,k)|H₁) that a data frame conforms to distribution of a noisy speech signal may be further expressed by the following equation (11):

$$P ( Y ( m , k ) \vert {H}_{1} ) = \frac{1}{{\vert N ( m , k ) \vert}^{2} + {\vert X ( m , k ) \vert}^{2}} \times exp ( - \frac{{\vert Y ( m , k ) \vert}^{2}}{{\vert N ( m , k ) \vert}^{2} + {\vert X ( m , k ) \vert}^{2}} ) . \qquad ( 11 )$$

Based on the calculation of the likelihood ratio in equation (9), a relationship among the likelihood ratio, the prior signal-to-noise ratio and the posterior signal-to-noise ratio is expressed by the following equation (12):

$$Λ ( m , k ) = \frac{exp ( σ ( m , k ) \times \frac{ρ ( m , k )}{( ρ ( m , k ) + 1 )} )}{ρ ( m , k ) + 1} . \qquad ( 12 )$$

In equation (12), Λ(m, k) represents the likelihood ratio at the k-th frequency of the m-th frame, σ(m,k) represents the posterior signal-to-noise ratio at the k-th frequency of the m-th frame, ρ(m, k) represents the prior signal-to-noise ratio at the k-th frequency of the m-th frame, and exp( ) represents an exponential function with a natural constant e as a base, and an exponent indicated in parentheses. Reference is made to equation (7) and equation (8) for calculations of the prior signal-to-noise ratio and the posterior signal-to-noise ratio.

In an embodiment, the noisy speech signal and the noise signal each is expressed under a Gaussian distribution. Hence, a relationship between the likelihood ratio and the prior signal-to-noise ratio and the posterior signal-to-noise ratio is established, and the likelihood ratio of the speech presence probability in each data frame is expressed with the prior signal-to-noise ratio and the posterior signal-to-noise ratio.

It is noted that the distribution of the noisy speech signal and the noise signal includes, but is not limited to, the Gaussian distribution, and other distributions, such as a Laplace distribution, are possible. For another distribution, the calculation of the likelihood ratio may be adjusted accordingly.

In an embodiment, the speech presence probability (also referred to as a posterior probability of speech presence) is calculated based on the likelihood ratio and the prior probability of speech absence based on the following equation (13):

$$phat ( m , k ) = \frac{( 1 - q ( m , k ) ) Λ ( m , k )}{q ( m , k ) + ( 1 - q ( m , k ) ) Λ ( m , k )} . \qquad ( 13 )$$

In equation (13), phat(m,k) represents the speech presence probability at the k-th frequency of the m-th frame, and q(m, k) represents the prior probability of speech absence at the k-th frequency of the m-th frame.

In an embodiment, after calculating the likelihood ratio based on the prior signal-to-noise ratio and the posterior signal-to-noise ratio, the method may further include: performing an inter-frequency smoothing on the likelihood ratio to obtain a smoothed likelihood ratio. The calculating a speech presence probability based on the likelihood ratio and the prior probability of speech absence includes: calculating the speech presence probability based on the smoothed likelihood ratio and the prior probability of speech absence.

After the likelihood ratio is obtained, the inter-frequency smoothing may be performed on the likelihood ratio according to the following equation (14):

Λₛₘₒₒₜₕ=Σᵢ₌₋ₘ^{m}w(i)Λ(m,k−i)tm (14).

In equation (14) Λₛₘₒₒₜₕ represents the smoothed likelihood ratio, and there has Σᵢ₌₋ₘ^{m}w(i)=1, where m is a constant.

Correspondingly, equation (13) is updated, using the smoothed likelihood ratio, as the following equation (13′):

$$phat ( m , k ) = \frac{( 1 - q ( m , k ) ) {Λ}_{s m o o t h}}{q ( m , k ) + ( 1 - q ( m , k ) ) {Λ}_{s m o o t h}} . \qquad ( {13}^{′} )$$

The posterior signal-to-noise ratio is required when calculating Λₛₘₒₒₜₕ the posterior signal-to-noise ratio is an instantaneous value, and varies significantly among individual frequencies. After the inter-frequency smoothing with consideration of information of adjacent frequencies, the noise estimation is more accurate and can prevent a spectrum leakage.

In an embodiment, after the speech presence probability phat(m,k) is obtained, it is determined whether a deadlock occurs by using a smoothed value phatₛₘₒₒₜₕ(m,k) of the speech presence probability. The phatₛₘₒₒₜₕ(m,k) may be expressed as the following equation (15):

phatₛₘₒₒₜₕ(m,k)=α×phatₛₘₒₒₜₕ(m−1,k)+(1−α)×phat(m,k) (15).

In equation (15), phatₛₘₒₒₜₕ(m, k) represents an estimated speech presence probability at the k-th frequency of the m-th frame, a represents a predetermined constant ranging from 0 to 1, and phatₛₘₒₒₜₕ(m−1,k) represents a smoothed value of the estimated speech presence probability at the k-th frequency of a previous frame (i.e., the (m-1)-th frame).

In a case that phatₛₘₒₒₜₕ(m, k) is greater than a predetermined probability threshold, the posterior probability of speech presence, phat(m, k), may remain to be 1 for several frames previous to the current frame due to a smoothing delay. Thereby, a deadlock occurs and causes failure of update of the noise estimation. Therefore, the following determination is added in order to prevent the deadlock and speed up the update of the noise estimation.

The following equation (16) may be applied to determine whether a deadlock occurs and update the posterior probability of speech presence which may cause a deadlock:

$$phat ( m , k ) = \{ \begin{matrix}p h a {t}_{max} , pha {t}_{s m o o t h} \geq p h a {t}_{max} \\ \frac{( 1 - q ( m , k ) ) {Λ}_{s m o o t h}}{q ( m , k ) + ( 1 - q ( m , k ) ) {Λ}_{s m o o t h}} , pha {t}_{s m o o t h} < p h a {t}_{max}\end{matrix} . \qquad ( 16 )$$

In equation (16), phatₘₐₓ represents a probability threshold for preventing a deadlock, and is a constant ranging from 0 to 1.

Reference is made to FIG. 2. In an embodiment, the step S206 of calculating the estimated noise power spectrum based on the speech presence probability includes: performing a first-order recursive smoothing on a power spectrum of the noisy speech signal based on the following equation (17), to obtain a noise power spectrum in an estimated frequency band. Equation (17) is expressed by

|\hat{N}(m,k)|²=∂ₙ×|\hat{N}(m−1,k)|²+(1−∂ₙ)×|Y(m,k)|² (17).

In equation (17), |\hat{N}(m,k)|² represents an estimated noise power at the k-th frequency of the m-th frame, and is also an expression for the estimated noise power spectrum; |\hat{N}(m−1,k)|² represents an estimated noise power at the k-th frequency of a previous frame, i.e., the (m−1)-th frame; |Y(m,k)|² represents a real-time power at the k-th frequency of the m-th frame; and ∂ₙ represents an adaptive smoothing factor restricted by the speech presence probability p(m,k). ∂ₙ may be expressed by the following equation (18):

∂ₙ=∂_{d}+(1−∂₃)×p(m,k) (18).

In equation (18), ∂_{d} represents a predetermined smoothing factor, which is a constant set empirically or experimentally. There has 0≤∂_{d}≤1 and ∂_{d}≤∂ₙ≤1.

In an embodiment, in an initial stage in which the estimated noise power of a previous frame is not available, the posterior signal-to-noise ratio is calculated by using the current real-time power as the estimated noise power of the previous frame.

In the embodiment, a method for calculating a speech presence probability in a continuous spectrum and a method for noise estimation based on the speech presence probability in the continuous spectrum are provided, so that the speech presence probability in the continuous spectrum is tracked continuously and a result of the noise estimation is updated in real-time.

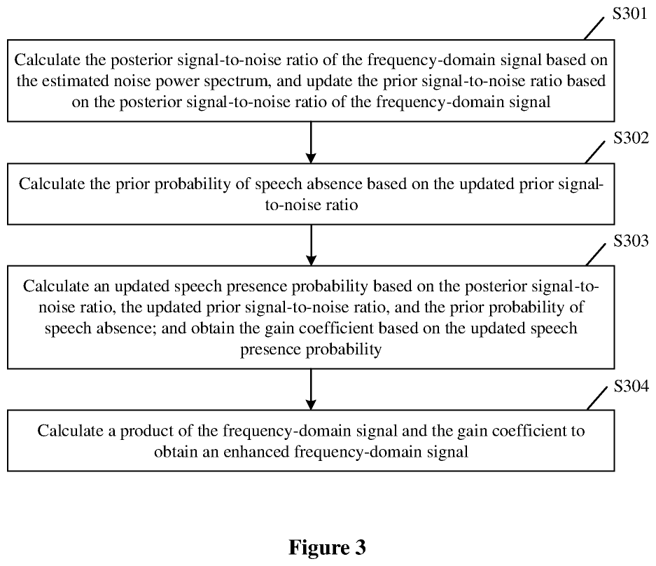

Reference is made to FIG. 1 and FIG. 3. In an embodiment, step S104 of calculating a gain coefficient based on the estimated noise power spectrum and enhancing the frequency-domain signal based on the gain coefficient to obtain an enhanced frequency-domain signal, as shown in FIG. 1, may include steps S301 to S304 in FIG. 3.

In step S301, the posterior signal-to-noise ratio of the frequency-domain signal is calculated based on the estimated noise power spectrum, and the prior signal-to-noise ratio is updated based on the posterior signal-to-noise ratio of the frequency-domain signal.

The posterior signal-to-noise ratio of the frequency-domain signal is calculated based on the noise power spectrum |\hat{N}(m,k)|² obtained from the noise estimation as described above. The calculation is expressed by the following equation (19):

$${\hat{σ}}_{1} ( m , k ) = \frac{{\vert Y ( m , k ) \vert}^{2}}{{\vert \hat{N} ( m , k ) \vert}^{2}} . \qquad ( 19 )$$

In equation (19), |\hat{N}(m,k)|² represents the noise power spectrum, that is, indicates a noise power at the k-th frequency of the m-th frame; |Y(m,k)|² represents the real-time power spectrum, that is, indicates a real-time power at the k-th frequency of the m-th frame; and \hat{σ}₁(m,k) represents the posterior signal-to-noise at the k-th frequency of the m-th frame.

The prior signal-to-noise may be updated by substituting the posterior signal-to-noise \hat{σ}₁(m,k) of the frequency-domain signal into the following equation (20).

\hat{ρ}₁(m,k)=max(γ_{dd}\hat{ρ}₁)(m−1,k)+(1−γ_{dd})max(\hat{σ}₁(m,k)−1,0), \hat{ρ}₁ₘᵢₙ) (20)

In equation (20), γ_{dd} represents a time smoothing parameter, which is a predetermined constant. The prior signal-to-noise ratio is a smoothed result of the posterior signal-to-noise ratio, with a time delay. A greater γ_{dd} results in a greater time delay. \hat{ρ}₁(m,k) represents the updated prior signal-to-noise ratio at the k-th frequency of the m-th frame.

In step S302, a prior probability of speech absence is calculated based on the updated prior signal-to-noise ratio.

In an embodiment, the prior probability of speech absence is calculated according to equation (21):

$$d ( m , k ) = \{ \begin{matrix}0 , & {\hat{ρ}}_{1} ( m , k ) \geq {ρ}_{max} ( m , k ) \\ 1 , & {\hat{ρ}}_{1} ( m , k ) \leq {ρ}_{min} ( m , k ) \\ \frac{{ρ}_{max} ( m , k ) - {\hat{ρ}}_{1} ( m , k )}{{ρ}_{max} ( m , k ) - {ρ}_{min} ( m , k )} , & {ρ}_{min} ( m , k ) < {\hat{ρ}}_{1} ( m , k ) < {ρ}_{max} ( m , k )\end{matrix} . \qquad ( 21 )$$

In equation (21), d(m,k) represents the prior probability of speech absence; \hat{ρ}₁(m,k) represents the updated prior signal-to-noise ratio; ρₘₐₓ(m,k) represents a maximum value of the prior signal-to-noise ratio; and ρₘᵢₙ(m,k) represents a minimum value of the prior signal-to-noise ratio. ρₘₐₓ(m,k) and ρₘᵢₙ(m,k) are predetermined.

According to the conventional OMLSA, the prior probability of speech absence is calculated by using an MMSE estimator. Based on a strong correlation between adjacent frequencies of continuous frames, the prior signal-to-noise ratio is empirically measured as ranging from ρₘᵢₙ(m,k) to ρₘₐₓ(m,k). Calculation of a “local” or “global” likelihood probability of speech presence in the OMLSA algorithm may be replaced by calculation of a prior probability of absence of a single speech. The calculation of the prior probability of speech absence may be referred to equation (21).

In an embodiment, an empirical value of ρₘₐₓ(m,k) is 0.3162, which corresponds to −5 dB; and an empirical value of ρₘᵢₙ(m,k) is 0.1, which corresponds to −10 dB.

In an embodiment, the prior probability of speech absence is calculated based on the smoothed prior signal-to-noise ratio.

In step S303, an updated speech presence probability is calculated based on the posterior signal-to-noise ratio, the updated prior signal-to-noise ratio and the prior probability of speech absence, and the gain coefficient is obtained based on the updated speech presence probability.

Referring again to equation (12), the likelihood ratio Λ(m,k) may be updated to Λ′(m,k), expressed by

$${Λ}^{′} ( m , k ) = \frac{exp ( {\hat{σ}}_{1} ( m , k ) \times \frac{{\hat{ρ}}_{1} ( m , k )}{( {\hat{ρ}}_{1} ( m , k ) + 1 )} )}{{\hat{ρ}}_{1} ( m , k ) + 1} .$$

The updated speech presence probability phat₁(m,k) is calculated based on Λ′(m,k), the updated prior signal-to-noise ratio \hat{ρ}₁(m,k), the posterior signal-to-noise ratio \hat{σ}₁(m, k), and the prior probability d(m,k) of speech absence., The updated speech presence probability is expressed by the following equation (22):

$$p h a {t}_{1} ( m , k ) = \frac{( 1 - d ( m , k ) ) {Λ}^{′} ( m , k )}{d ( m , k ) + ( 1 - d ( m , k ) ) {Λ}^{′} ( m , k )} . \qquad ( 22 )$$

With the updated speech presence probability phat₁(m,k), the gain coefficient corresponding to a frame in the real-time power spectrum may be calculated, so that a gain of the real-time power spectrum can be calculated.

In step S304, a product of the frequency-domain signal and the gain coefficient is calculated to obtain the enhanced frequency-domain signal.

In an embodiment, the gain coefficient is calculated through the following equation (23):

Gain(m,k)=max(GH1^{phat}^{₁}^{(m,k)}×GH0^{*1-phat}^{₁}^{(m,k))},Gₘᵢₙ) (23).

In equation (13), GH0 represents a predetermined non-zero constant with a small value; and Gₘᵢₙ represents a predetermined minimum for restricting a degree of noise suppression.

GH1 may be calculated through the following equation (24):

$$GH 1 = \frac{{\hat{ρ}}_{1} ( m , k )}{( {\hat{ρ}}_{1} ( m , k ) + 1 )} \times exp ( 0.5 \times \int {v}_{1} ( m , k ) ) , \qquad ( 24 )$$

$$where , {v}_{1} ( m , k ) = {σ}_{1} ( m , k ) \times \frac{{β}_{1} ( m , k )}{( {β}_{1} ( m , k ) + 1 )}$$

In equation (24), ∫( ) represents an operation of calculating an integral of a value in parentheses.

The enhanced frequency-domain signal may be obtained through the following equation (25):

X(m,k)=Y(m,k)×Gain(m,k) (25).

In equation (15), X(m, k) represents the enhanced frequency-domain signal at the k-th frequency of the m-th frame; and Y(m, k) represents the frequency-domain signal at the k-th frequency of the m-th frame.

In the embodiment, a simplified OMLSA algorithm is applied to calculate the gain and thereby obtain an enhanced speech. The calculation of a “local” or “global” likelihood probability of speech presence in the OMLSA algorithm is replaced by calculation of the prior probability of absence of a single speech. Hence, calculation of the prior probability of speech absence is simplified without influencing a performance of noise suppression, so that the computational complexity is reduced.

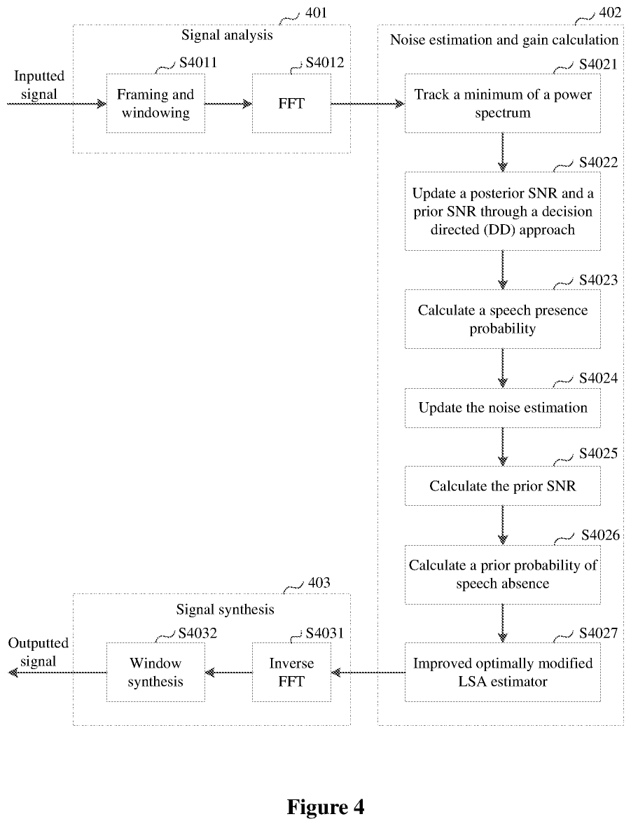

Reference is made to FIG. 4, which illustrates a schematic diagram of a noise suppression system in an application example of the present disclosure. The noise suppression system includes three sections, i.e., a signal analysis section 401, a noise estimation and gain calculation section 402, and a signal synthesis section 403.

The signal analysis section 401 is configured to perform the following pre-processes, S4011 and S4012, on an input signal to obtain a frequency-domain signal.

In step S4011, framing and windowing are performed.

In step S4012, a fast Fourier transform (FFT) is performed.

The noise estimation and gain calculation section 402 is configured to perform noise estimation, steps S4021 to S4024, on the frequency-domain signal to update a noise power spectrum.

In step S4021, a minimum in a power spectrum of a noisy speech is tracked.

In step S4022, a posterior signal-to-noise ratio and a prior signal-to-noise ratio are updated by using a decision-directed approach.

In step S4023, a speech presence probability is calculated.

In step S4024, the noise power spectrum is updated.

The noise estimation and gain calculation section 402 is configured to perform gain calculation, steps S4025 to S4027, on the updated noise power spectrum, to obtain an enhanced speech signal.

In step S4025, the prior signal-to-noise ratio is calculated.

In step S4026, the prior probability of speech absence is calculated.

In step S4027, the OMLSA is improved and is applied to calculate the gain and thereby obtain the enhanced speech.

The signal synthesis section 403 is configured to convert the enhanced speech from the frequency domain to the time domain through steps S4031 and S4032, to obtain an output signal.

In step S4031, an inverse Fourier transform, i.e., inverse FFT, is performed.

In step S4032, window synthesis is performed.

With the technical solutions of the present disclosure, noise in the noisy speech can be suppressed quickly and accurately. The technical solutions according to the present disclosure have the following advantages compared to the conventional noise estimation algorithms. Compared with calculation of the prior probability of speech absence according to the MCRA2, a linear threshold is used for the ratio of the smoothed speech signal power to the minimum of the noise power spectrum in the embodiments of the present disclosure, which solves the overestimation in the MCRA2 and thus the noise power spectrum can be estimated accurately and efficiently. Compared with the IMCRA, the minimum is tracked faster and the calculation is simpler in the present disclosure. Compared with the conventional OMLSA algorithm, the calculation of the prior probability of speech absence in the present disclosure is simplified while ensuring an effect of speech enhancement, so that a complexity of the algorithm is reduced.

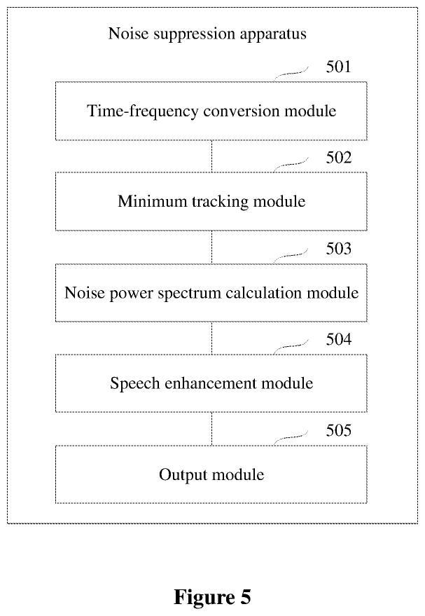

Reference is made to FIG. 5. An apparatus for suppressing noise by quickly calculating speech presence probability is provided according to the present disclosure. The apparatus may include a time-frequency conversion module 501, a minimum tracking module 502, a noise power spectrum calculation module 503, a speech enhancement module 504, and an output module 505.

The time-frequency conversion module 501 is configured to obtain an input signal, and convert the input signal from a time-domain signal to a frequency-domain signal.

The minimum tracking module 502 is configured to calculate a real-time power spectrum of the frequency-domain signal, and track a minimum power in the real-time power spectrum.

The noise power spectrum calculation module 503 is configured to perform noise estimation based on the minimum power to obtain an estimated noise power spectrum.

The speech enhancement module 504 is configured to calculate a gain coefficient based on the estimated noise power spectrum, and enhance the frequency-domain signal based on the gain coefficient to obtain an enhanced frequency-domain signal.

The output module 505 is configured to convert the enhanced frequency-domain signal to a time-domain signal to obtain an output signal.

Further details of operating principles and methods of the apparatus may be referred to the related description of the method for suppressing noise by quickly calculating a speech presence probability as shown in FIG. 1 to FIG. 4, and are not repeated here.

In a specific implementation, the apparatus for suppressing noise by quickly calculating speech presence probability may correspond to: a chip in a terminal having a function of suppressing noise by quickly calculating a speech presence probability; a chip having a data processing capability, such as a System-on-a-Chip (SOC), or a baseband chip; a chip module in a terminal including a chip having a function of suppressing noise by quickly calculating a speech presence probability; a chip module including a chip having a data processing capability; or a terminal.

In an implementation, modules/units included in the apparatuses and the products described in the above embodiments may be software modules/units, hardware modules/units, or partly software modules/units and partly hardware modules/units.

For example, for the apparatuses or products applied to or integrated in a chip, modules/units included therein may be implemented by hardware such as circuits. Alternatively, at least some of the modules/units may be implemented by a software program executed on a processor integrated inside the chip, and the remaining part (if any) of the modules/units may be implemented by hardware such as circuits. For the apparatuses or products applied to or integrated in a chip module, modules/units included therein may be implemented by hardware such as circuits, and different modules/units may reside in a same component (such as a chip or a circuit module) or different components of the chip module. Alternatively, at least some of the modules/units may be implemented by software programs executed on a processor integrated inside the chip module, and the remaining part (if any) of the modules/units may be implemented by hardware such as circuits. For the apparatus or products applied to or integrated in a terminal, modules/units included therein may be implemented by hardware such as circuits, and different modules/units may reside in a same component (such as a chip or a circuit module) or different components of the terminal. Alternatively, at least some of the modules/units may be implemented by software programs executed on a processor integrated inside the terminal, and the remaining part (if any) of the modules/units may be implemented by hardware such as circuits.

A storage medium is further provided according to an embodiment of the present disclosure. The storage medium stores computer instructions. The computer instructions, when executed, perform the method for suppressing noise by quickly calculating a speech presence probability according to any of the embodiments shown in FIG. 1 to FIG. 4. Preferably, the storage medium may include a non-volatile memory, a non-transitory memory, or other computer-readable storage mediums. The storage medium may include an ROM, an RAM, a magnetic disk, an optical disk, or the like.

A terminal is further provided according to an embodiment of the present disclosure. The terminal includes the apparatus for suppressing noise by quickly calculating a speech presence probability. Alternatively, the terminal includes a memory and a processor. The memory stores computer instructions that are executable on the processor. The processor, when executing the computer instructions, performs the method for suppressing noise by quickly calculating a speech presence probability according to any of the embodiments shown in FIG. 1 to FIG. 4. The terminal may be a mobile phone, a computer, a server, or the like.

The MCRA, MCRA2, IMCRA and other methods mentioned in the present disclosure are well-known methods for noise estimation and are not intended to limit specific implementations. The methods such as the OMLSA algorithm and Wiener filtering mentioned in the present disclosure are well-known algorithms for calculating a gain, and are not intended to limit specific implementations. The reference and recommended values given in the present disclosure are obtained in practice, and the given ranges are not intended to limit a practical application. The method for suppressing noise proposed in the present disclosure includes two parts, i.e., noise estimation and gain calculation. Substitution of one of the two parts falls within the scope of the present disclosure. Other methods for calculating the speech presence probability fall within the scope of the present disclosure.

It should be understood that a term “and/or” in the present disclosure indicates three possible relationships between related objects. For example, “A and/or B” may indicate the following three cases: merely A, both A and B, and merely B. In addition, the character “/” in the present disclosure indicates an “or” relationship.

The word “multiple” used in the embodiments of present disclosure refers to two or more.

The “first”, “second”, and the like, are used in the embodiments of the present disclosure in order to illustrate and distinguish objects from each other, and are not intended to indicate an order of the objects or limit quantities of devices in the embodiments of the present disclosure. Such terms shall not constitute any limitation on the embodiments of the present disclosure.

The term “connect” in the embodiments of the present disclosure indicates a direct connection, an indirect connection, or other connections for communication between devices, which is not limited herein.

Although disclosed as above, the present disclosure is not limited thereto. Various variations and modifications may be made by those skilled in the art without departing from the spirit and scope of the present disclosure. Therefore, the protection scope of the present disclosure should conform to the scope defined by the claims.

1. A method for suppressing noise by quickly calculating a speech presence probability, comprising:
obtaining an input signal, and converting the input signal from a time-domain signal to a frequency-domain signal;
calculating a real-time power spectrum of the frequency-domain signal, and tracking a minimum power in the real-time power spectrum;
performing noise estimation based on the minimum power to obtain an estimated noise power spectrum;
calculating a gain coefficient based on the estimated noise power spectrum, and enhancing the frequency-domain signal based on the gain coefficient to obtain an enhanced frequency-domain signal; and
converting the enhanced frequency-domain signal to a time-domain signal to obtain an output signal.

2. The method according to claim 1, wherein the performing noise estimation based on the minimum power to obtain an estimated noise power spectrum comprises:
calculating a ratio of a real-time power to the minimum power in the real-time power spectrum;
obtaining a threshold and comparing the ratio with the threshold to obtain a prior probability of speech absence;
calculating a posterior signal-to-noise ratio based on the real-time power spectrum, wherein the posterior signal-to-noise ratio is a ratio of a real-time power of a current frame to an estimated noise power of a previous frame;
calculating a prior signal-to-noise ratio through a decision-directed approach;
calculating a speech presence probability based on the prior signal-to-noise ratio, the posterior signal-to-noise ratio, and the prior probability of speech absence; and
calculating the estimated noise power spectrum based on the speech presence probability.

3. The method according to claim 2, wherein the prior probability of speech absence is obtained as:
$$q ( m , k ) = \{ \begin{matrix}0 , & Srk \geq Δ \\ 1 , & Srk \leq alpha \times Δ \\ \frac{Δ - S r k}{Δ - alpha \times Δ} , & alpha \times Δ < S r k < Δ\end{matrix}$$
where Pₘᵢₙ(m,k) represents a minimum power of a noisy speech at a k-th frequency of an m-th frame; P(m,k) represents a smoothed real-time power at the k-th frequency of the m-th frame; Srk represents the ratio and satisfies
$$Srk = \frac{P ( m , k )}{{P}_{min} ( m , k )} ;$$
alpha represents a predetermined constant and ranges from 0 to 1; Δ represents a threshold set by frequencies based on a characteristic of noise distribution; and q(m,k) represents the prior probability of speech absence at the k-th frequency of the m-th frame.

4. The method according to claim 3, wherein the threshold is set as:
Δ=a×(tanhw₁(x−thres)+b)+c
where a, b, and c represent predetermined constants, thres represents a predetermined value based on a signal-to-noise ratio of a current frame of a speech signal, and w₁ represents a constant for restricting a mapping curvature of a curve consisting of values of Δ, wherein w₁ ranges from 0 to 1.

5. The method according to claim 3, wherein the calculating a speech presence probability based on the prior signal-to-noise ratio, the posterior signal-to-noise ratio, and the prior probability of speech absence comprises:
calculating a likelihood ratio based on the prior signal-to-noise ratio and the posterior signal-to-noise ratio, wherein the likelihood ratio indicates a ratio of a probability that a received data frame conforms to a distribution of a noisy speech signal to a probability that the data frame conforms to a distribution of a noise signal; and
calculating the speech presence probability based on the likelihood ratio and the prior probability of speech absence.

6. The method according to claim 5, wherein the noisy speech signal and the noise signal each satisfies a Gaussian distribution, and the likelihood ratio is expressed as:
$$Λ ( m , k ) = \frac{exp ( σ ( m , k ) \times \frac{ρ ( m , k )}{( ρ ( m , k ) + 1 )} )}{ρ ( m , k ) + 1} ,$$
where Λ(m,k) represents the likelihood ratio at the k-th frequency of the m-th frame;
σ(m, k) represents the posterior signal-to-noise ratio at the k-th frequency of the m-th frame; ρ(m,k) represents the prior signal-to-noise ratio at the k-th frequency of the m-th frame; and exp( ) represents an exponential function having a natural constant e as a base, and an exponent indicated in parentheses.

7. The method according to claim 6, wherein the speech presence probability is calculated as:
$$phat ( m , k ) = \frac{( 1 - q ( m , k ) ) Λ ( m , k )}{q ( m , k ) + ( 1 - q ( m , k ) ) Λ ( m , k )}$$
where phat(m,k) represents the speech presence probability at the k-th frequency of the m-th frame; and q(m, k) represents the prior probability of speech absence at the k-th frequency of the m-th frame.

8. The method according to claim 6, wherein
after the calculating a likelihood ratio based on the prior signal-to-noise ratio and the posterior signal-to-noise ratio, the method further comprises:
performing an inter-frequency smoothing on the likelihood ratio to obtain a smoothed likelihood ratio; and
the calculating a speech presence probability based on the likelihood ratio and the prior probability of speech absence comprises:
calculating the speech presence probability based on the smoothed likelihood ratio and the prior probability of speech absence.

9. The method according to claim 5, wherein after the calculating the speech presence probability based on the likelihood ratio and the prior probability of speech absence, the method further comprises:
obtaining a probability threshold; and
determining whether to update the speech presence probability based on a relationship between the speech presence probability and the probability threshold.

10. The method according to claim 9, wherein
a smoothed value of the speech presence probability is calculated as:
phatₛₘₒₒₜₕ(m,k)=α×phatₛₘₒₒₜₕ(m−1,k)+(1−α)×phat(m,k),
where phatₛₘₒₒₜₕ(m,k) represents the smoothed value of the speech presence probability at the k-th frequency of the m-th frame; and a represents a predetermined constant and ranges from 0 to 1; and
the speech presence probability is updated as:
$$phat ( m , k ) = \{ \begin{matrix}p h a {t}_{max} , pha {t}_{s m o o t h} \geq p h a {t}_{max} \\ \frac{( 1 - q ( m , k ) ) {Λ}_{s m o o t h}}{q ( m , k ) + ( 1 - q ( m , k ) ) {Λ}_{s m o o t h}} , pha {t}_{s m o o t h} < p h a {t}_{max}\end{matrix} ,$$
where phatₘₐₓ represents the probability threshold and is a predetermined constant.

11. The method according to claim 2, wherein in a case that the estimated noise power spectrum does not contain the estimated noise power of the previous frame, the posterior signal-to-noise ratio is calculated by using a current real-time power as the estimated noise power of the previous frame.

12. The method according to claim 1, wherein the calculating a gain coefficient based on the estimated noise power spectrum, and enhancing the frequency-domain signal based on the gain coefficient to obtain an enhanced frequency-domain signal comprises:
calculating a posterior signal-to-noise ratio of the frequency-domain signal based on the estimated noise power spectrum, and updating the prior signal-to-noise ratio based on the posterior signal-to-noise ratio of the frequency-domain signal;
calculating a prior probability of speech absence based on the updated prior signal-to-noise ratio;
calculating an updated speech presence probability based on the posterior signal-to-noise ratio, the updated prior signal-to-noise ratio, and the prior probability of speech absence;
obtaining the gain coefficient based on the updated speech presence probability; and
calculating a product of the frequency-domain signal and the gain coefficient to obtain the enhanced frequency-domain signal.

13. The method according to claim 12, wherein the prior probability of speech absence is calculated as:
$$d ( m , k ) = \{ \begin{matrix}0 , & {\hat{ρ}}_{1} ( m , k ) \geq {ρ}_{max} ( m , k ) \\ 1 , & {\hat{ρ}}_{1} ( m , k ) \leq {ρ}_{min} ( m , k ) \\ \frac{{ρ}_{max} ( m , k ) - {\hat{ρ}}_{1} ( m , k )}{{ρ}_{max} ( m , k ) - {ρ}_{min} ( m , k )} , & {ρ}_{min} ( m , k ) < {\hat{ρ}}_{1} ( m , k ) < {ρ}_{max} ( m , k )\end{matrix} ,$$
where d(m, k) represents the prior probability of speech absence; \hat{ρ}₁(m, k) represents the updated prior signal-to-noise ratio; ρmax(m, k) represents a maximum value of the prior signal-to-noise ratio; and ρₘᵢₙ(m,k) represents a minimum value of the prior signal-to-noise ratio, wherein ρₘₐₓ(m,k) and ρₘᵢₙ(m,k) are predetermined.

14. (canceled)

15. A non-transitory storage medium storing a computer program, wherein the computer program, when executed by a processor, is configured to:
obtain an input signal, and convert the input signal from a time-domain signal to a frequency-domain signal;
calculate a real-time power spectrum of the frequency-domain signal, and track a minimum power in the real-time power spectrum;
perform noise estimation based on the minimum power to obtain an estimated noise power spectrum;
calculate a gain coefficient based on the estimated noise power spectrum, and enhance the frequency-domain signal based on the gain coefficient to obtain an enhanced frequency-domain signal; and
convert the enhanced frequency-domain signal to a time-domain signal to obtain an output signal.

16. A terminal, comprising:
a memory storing a computer program, and
a processor, wherein
the computer program, when executed by the processor, configures the processor to:
obtain an input signal, and convert the input signal from a time-domain signal to a frequency-domain signal;
calculate a real-time power spectrum of the frequency-domain signal, and track a minimum power in the real-time power spectrum;
perform noise estimation based on the minimum power to obtain an estimated noise power spectrum;
calculate a gain coefficient based on the estimated noise power spectrum, and enhance the frequency-domain signal based on the gain coefficient to obtain an enhanced frequency-domain signal; and
convert the enhanced frequency-domain signal to a time-domain signal to obtain an output signal.

17. The terminal according to claim 16, wherein the processor is further configured to:
calculate a ratio of a real-time power to the minimum power in the real-time power spectrum;
obtain a threshold and compare the ratio with the threshold to obtain a prior probability of speech absence;
calculate a posterior signal-to-noise ratio based on the real-time power spectrum, wherein the posterior signal-to-noise ratio is a ratio of a real-time power of a current frame to an estimated noise power of a previous frame;
calculate a prior signal-to-noise ratio through a decision-directed approach;
calculate a speech presence probability based on the prior signal-to-noise ratio, the posterior signal-to-noise ratio, and the prior probability of speech absence; and
calculate the estimated noise power spectrum based on the speech presence probability.

18. The terminal according to claim 17, wherein the prior probability of speech absence is obtained as:
$$q ( m , k ) = \{ \begin{matrix}0 , & Srk \geq Δ \\ 1 , & Srk \leq alpha \times Δ \\ \frac{Δ - S r k}{Δ - alpha \times Δ} , & alpha \times Δ < S r k < Δ\end{matrix}$$
where Pₘᵢₙ(m, k) represents a minimum power of a noisy speech at a k-th frequency of an m-th frame; P(m,k) represents a smoothed real-time power at the k-th frequency of the m-th frame; Srk represents the ratio and satisfies
$$Srk = \frac{P ( m , k )}{{P}_{min} ( m , k )} ;$$
alpha represents a predetermined constant and ranges from 0 to 1; Δ represents a threshold set by frequencies based on a characteristic of noise distribution; and q(m, k) represents the prior probability of speech absence at the k-th frequency of the m-th frame.

19. The terminal according to claim 18, wherein the processor is further configured to:
calculate a likelihood ratio based on the prior signal-to-noise ratio and the posterior signal-to-noise ratio, wherein the likelihood ratio indicates a ratio of a probability that a received data frame conforms to a distribution of a noisy speech signal to a probability that the data frame conforms to a distribution of a noise signal; and
calculate the speech presence probability based on the likelihood ratio and the prior probability of speech absence.

20. The terminal according to claim 19, wherein the processor is further configured to:
obtain a probability threshold; and
determine whether to update the speech presence probability based on a relationship between the speech presence probability and the probability threshold.

21. The terminal according to claim 16, wherein the processor is further configured to:
calculate a posterior signal-to-noise ratio of the frequency-domain signal based on the estimated noise power spectrum, and update the prior signal-to-noise ratio based on the posterior signal-to-noise ratio of the frequency-domain signal;
calculate a prior probability of speech absence based on the updated prior signal-to-noise ratio;
calculate an updated speech presence probability based on the posterior signal-to-noise ratio, the updated prior signal-to-noise ratio, and the prior probability of speech absence;
obtain the gain coefficient based on the updated speech presence probability; and
calculate a product of the frequency-domain signal and the gain coefficient to obtain the enhanced frequency-domain signal.
